(19) United States
(12) Patent Application Publication
(10) Pub. No.: US 2025/0155599 A1
(43) Pub. Date: May 15, 2025

(54) Metal Detector Coil

(71) Applicant: Minelab Electronics Pty. Limited, Mawson Lakes (AU)

(72) Inventors: Nicholas Luke Schultz, Mawson Lakes (AU); Sam Robertson England, Mawson Lakes (AU)

(21) Appl. No.: 18/838,648

(22) PCT Filed: Feb. 17, 2023
(86) PCT No.: PCT/AU2023/050105

§ 371 Date: Aug. 15, 2024

(30) Foreign Application Priority Data
Feb. 18, 2022 (AU) 2022900362

(51) Int. Cl. G01V 3/10

(52) U.S. Cl. CPC G01V 3/10

(57) ABSTRACT

A metal detector coil including a housing, at least one winding assembly and at least one spacer, wherein the or each winding assembly and spacer are at least partially encapsulated in a potting material poured into the housing, and wherein the or each spacer is configured to create one or more voids within the potting material, and wherein the shape, size or positioning of the voids may be adapted or configured to adjust one or more mechanical properties of the metal detector coil.

### CROSS-REFERENCE TO RELATED APPLICATIONS

This application is the United States national phase of International Patent Application No. PCT/AU2023/050105 filed Feb. 17, 2023, and claims priority to Australian Provisional Patent Application No. 2022900362 filed Feb. 18, 2022, the disclosures of which are hereby incorporated by reference in their entireties.

### BACKGROUND OF THE INVENTION

### Field of the Invention

The present disclosure relates to a metal detector coil.

### Description of Related Art

Metal detectors used for gold, coin and treasure detecting work on the principle of transmitting a magnetic field and analysing a return signal from the target and environment. The magnetic transmitter is in the form of a transmit coil comprising transmit windings, with a varying electric current flowing through it produced by transmit electronics. The receiver is in the form of a receive coil comprising receive windings, connected to receive and signal processing electronics. The transmit and receiver windings are sometimes the same winding. The transmit and receive windings are housed within a coil housing, with the entire assembly typically referred to as a coil, where some or all of the electronics are attached to the coil via an electrical cable and/or wirelessly connected to an external control source.

Many metal detector coils are constructed using an encapsulation process, where the transmit and receive windings are positioned within the housing which is then filled with a potting material such as an epoxy in order to reduce relative movement between the windings, as well as to protect the windings and associated electronic components from impact, vibration and loose connections. Achieving a high coil stiffness is important for preventing relative winding movement, which can cause mechanically-induced false target signals.

Minimising coil weight is important for operator comfort during use. In order to reduce the overall weight of the coil, some manufacturers reduce the internal volume of the housing in order to reduce the amount of potting material required, resulting in asymmetric housing designs, angled winding geometries, top housing faces with indentations, or housings with reduced stiffness. These solutions typically reduce coil stiffness, which can affect the performance of the coil by allowing mechanical deformation and relative movement between the windings, producing mechanically-induced false signals. Others use foamed epoxies, or epoxies filled with glass beads to reduce the bulk density of the epoxy and hence lower the weight. These solutions typically have higher viscosities making it difficult for the epoxies to flow to required places within the coil, resulting in unwanted voids in the potting material that can also lead to mechanically-induced false signals.

It is against this background that the present disclosure has been developed.

### SUMMARY OF THE INVENTION

According to a first aspect, there is provided a metal detector coil comprising a housing, at least one winding assembly and at least one spacer, wherein the or each winding assembly and spacer are at least partially encapsulated in a potting material poured into the housing, and wherein the or each spacer is configured to create one or more voids within the potting material, and wherein the shape, size or positioning of the voids may be adapted or configured to adjust one or more mechanical properties of the metal detector coil.

In one form, the spacer comprises one or more pockets configured to create the voids within the potting material, and wherein the shape, size or positioning of the pockets may be adapted or configured to adjust one or more mechanical properties of the metal detector coil.

In one form, the at least one winding assembly is separated from an internal surface of the housing by at least one spacer.

In one form, the one or more pockets in the or each spacer are configured to prevent flow of potting material therein, thereby creating voids within the potting material.

In one form, the one or more pockets in the or each spacer are open volumes configured to trap air, and prevent flow of potting material therein, such that voids are created in the potting material.

In one form, the metal detector coil comprises an upper winding assembly and a lower winding assembly.

In one form, the at least one spacer separates the lower winding assembly from an upper internal surface of the housing.

In one form, the at least one spacer separates the upper winding assembly from a lower internal surface of the housing.

In one form, the upper and lower winding assemblies are separated from one another by the at least one spacer.

In one form, the at least one spacer is configured to position the upper and lower winding assemblies parallel to one another.

In one form, the at least one spacer is configured to position and separate two or more winding assemblies assembled in a concentric arrangement within the housing.

In one form, the at least one spacer separates a single winding assembly from an upper internal surface of the housing.

In one form, the housing comprises an upper portion and a lower portion.

In one form, the at least one spacer is part of a former configured to retain one or more windings from the at least one winding assembly.

In one form, the or each spacer is configured to create one or more voids between the spacer and either or both of the housing and the at least one winding assembly.

In one form, the housing comprises one or more pockets and the spacer is configured to enclose the one or more pockets by close fitment to the housing, thereby forming the one or more voids within the potting material.

According to a second aspect, there is provided a method of assembling a metal detector coil comprising a housing, at least one winding assembly and at least one spacer, wherein the or each winding assembly and spacer are at least partially encapsulated in a potting material poured into the housing, and wherein the or each spacer is configured to create one or more voids within the potting material, the method comprising the steps of locating the at least one winding assembly and at least one spacer within the housing, and encapsulating the at least one winding assembly and at least one spacer by pouring potting material into the housing, wherein voids are created within the potting material by the spacer.

### BRIEF DESCRIPTION OF DRAWINGS

Embodiments of the present invention will be discussed with reference to the accompanying drawings wherein:

FIG. 1 is a top perspective view of a metal detector coil, according to an embodiment;

FIG. 2 is a bottom perspective view of the metal detector coil of FIG. 1;

FIG. 3 is a top exploded view of the metal detector coil of FIG. 1, detailing an upper housing, upper winding assembly, spacer, lower winding assembly and lower housing;

FIG. 4 is a bottom exploded view of the metal detector coil of FIG. 1;

FIG. 5 is a bottom perspective view of the spacer of FIG. 3;

FIG. 6 is a top perspective view of the spacer of FIG. 3;

FIG. 7 is a bottom perspective view of the upper housing of FIG. 3;

FIG. 8 is a bottom perspective view of a partial assembly of the metal detector coil of FIG. 1, showing the upper winding assembly located in the upper housing;

FIG. 9 is a bottom perspective view of a partial assembly of the metal detector coil of FIG. 1, showing the spacer located in the upper housing, on top of the upper winding assembly;

FIG. 10 is a bottom perspective view of a partial assembly of the metal detector coil of FIG. 1, showing the lower winding assembly located in the upper housing, on top of the spacer; and

FIG. 11 is a bottom exploded view of a metal detector coil, according to an alternate embodiment.

### DESCRIPTION OF THE INVENTION

There is provided a metal detector coil 1, according to an embodiment. The coil 1 comprises a housing 100, at least one winding assembly 200, 300 and at least one spacer 400, wherein the or each winding 200, 300 and spacer 400 are at least partially encapsulated in a potting material poured into the housing. The or each spacer 400 is configured to create one or more voids within the potting material, wherein the shape, size or positioning of the voids may be adapted or configured to adjust one or more mechanical properties of the metal detector.

It can be seen that the spacer comprises one or more pockets 405 configured to create the voids within the potting material, and it will be appreciated that the shape, size or positioning of the pockets may be adapted or configured to adjust one or more mechanical properties of the metal detector coil.

While the primary function of the spacer 400 (which may also be referred to as an insert or core) is to create voids within the potting material, it will be appreciated that it may perform other functions and take on various forms, as described below.

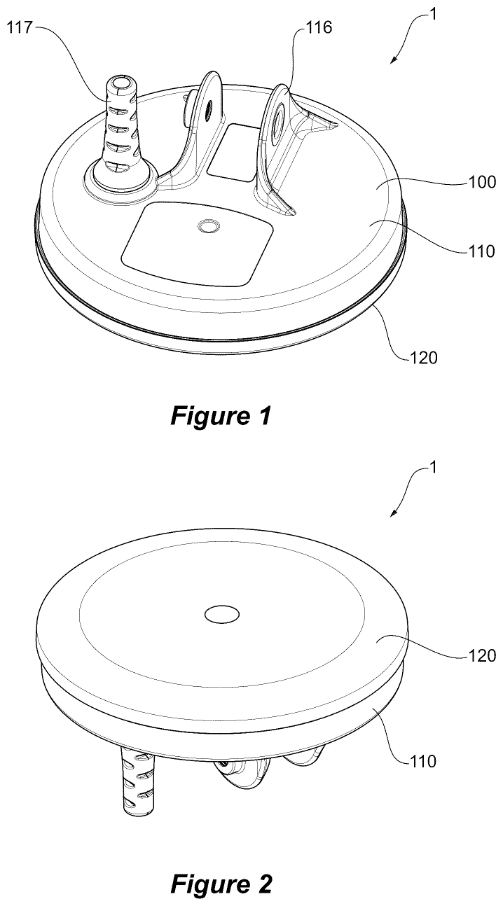

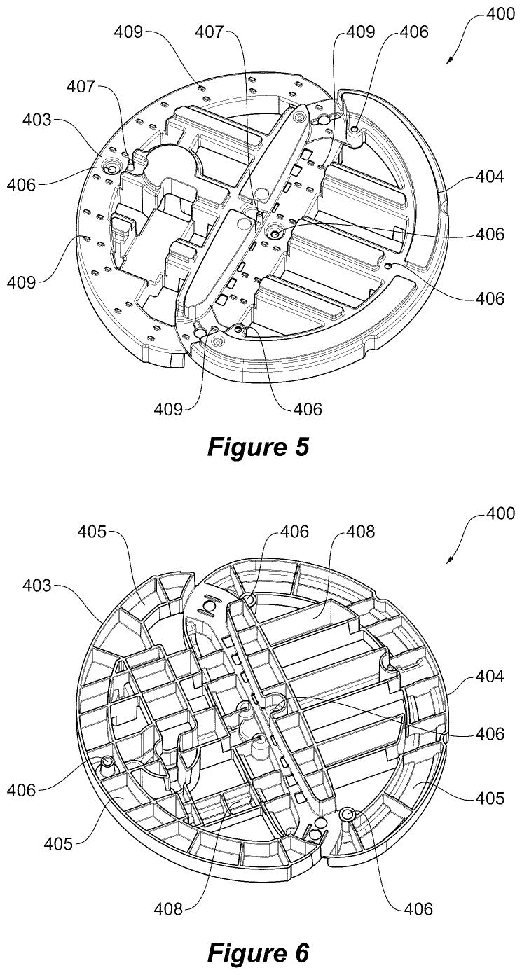

With reference to FIGS. 1 to 10, it can be seen that the coil 1 comprises a generally circular housing 100 having an upper portion 110 and a lower portion 120. The housing 100 is configured to accommodate upper and lower winding assemblies 200, 300 separated by a spacer 400. As best shown in FIGS. 5 and 6, the spacer 400 comprises an upper portion 403 for receiving the lower winding assembly 300 and a lower portion 404 for receiving the upper winding assembly 200. The upper and lower winding assemblies 200, 300 each comprise at least one winding in the form of an electrically conductive wire of one or more turns, which may be optionally housed within a plastic former or similar for assembly purposes. With particular reference to FIGS. 5 and 6, it can be seen that the spacer 400 comprises a plurality of pockets or openings 405, oriented such that when the upper and lower winding assemblies 200, 300 and the spacer 400 are encapsulated in the potting material, such as an epoxy, polyacrylate, urethane or silicone compound poured into the housing 100, the pockets 405, being open volumes are configured to trap air and prevent flow or entry of potting material therein.

While in the embodiment shown a circular housing 100 is employed, it will be appreciated that the same concept could equally apply to other shaped coils, such as elliptical or open-web coils.

As with conventional metal detector coils, the upper housing portion 110 comprises a bracket 116 for securing the coil to a shaft element, and an electrical cable 117 (partially shown), for connecting the winding assemblies 200, 300 to a control unit (not shown).

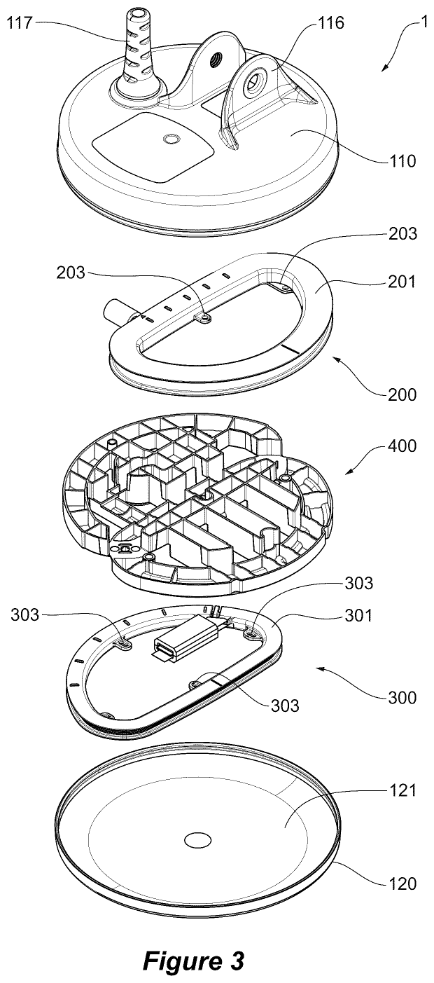

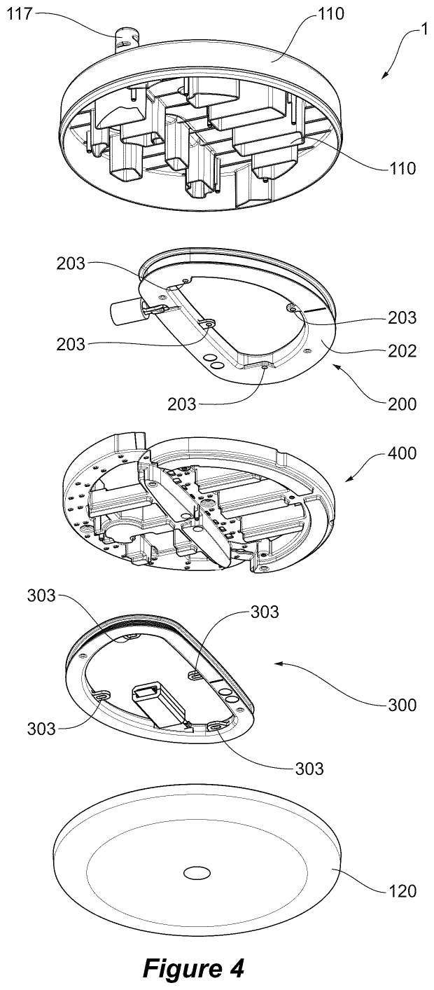

With reference to FIGS. 3 and 4, it can be seen that the coil 1 has what is known as a Double-D configuration, where the upper and lower winding assemblies 200, 300 are D shaped and overlapping. It will be appreciated that the spacer 400 performs the task of separating and positioning the two winding assemblies 200,300 in an overlapping configuration.

While not shown, it will be appreciated that a similar spacer concept could also be employed in alternative coil configurations such as concentric or monoloop arrangements, where the spacer 400 will be used to help position the winding assemblies 200, 300 within the housing 100, separate them from each other and/or the internal surface(s) of the housing 100 and provide pockets 405 for the purpose of weight reduction and adjustability of mechanical characteristics such as stiffness or buoyancy.

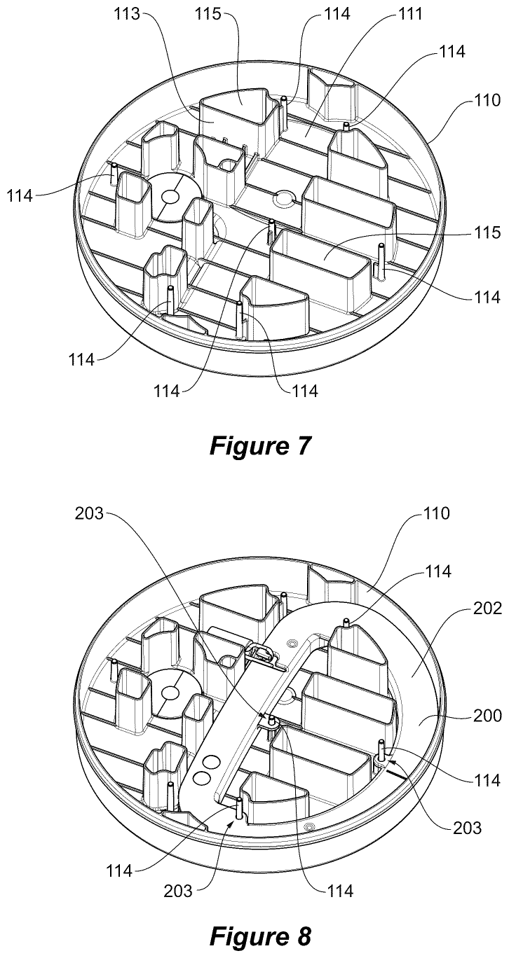

Returning again to FIGS. 1 to 4 where the Double-D configuration is employed, it will be appreciated that by virtue of the two D shaped winding assemblies 200, 300 being required to overlap, that the lower winding assembly 300 will be in close proximity to an internal surface 121 of the lower housing 120 and the upper winding assembly 200 will be in close proximity to an internal surface 111 (as shown in FIG. 7) the upper housing 110, resulting in a gap or volume forming between the lower winding assembly 300 and the internal surface 111 of the upper housing 110 and the upper winding assembly 200 and the internal surface 121 of the lower housing 120. Without the spacer 400 filling these gaps, these volumes would normally be filled with epoxy or some other potting material. It will be appreciated that the spacer 400 is configured to span these gaps, where the lower portion 404 sits between and separates the lower housing 120 and the upper winding assembly 200, and where the upper portion 403 sits between and separates the upper housing 110 and the lower winding assembly 300.

In the embodiment shown, the housing 100 comprises an upper housing portion 110 and a lower housing portion 120, where the lower housing portion 120 acts as a skid plate, protecting the encapsulated assembly. It will however be appreciated that the lower housing portion 120 is not required for the encapsulation process and is, in fact, a non-essential component. It will therefore be appreciated that in an alternate embodiment, the housing 100 would not completely enclose encapsulated components.

In this alternate embodiment, it will be appreciated that the spacer 400 would not separate the upper winding assembly 200 from the lower housing 120, instead the spacer 400 would fill the gap formed between a lower surface of the upper winding assembly 200 and the opening of the upper housing 110 or the finished epoxy or potting material level.

Assembly of the winding assemblies 200, 300 and spacer 400 within the housing 100 prior to encapsulation will now be described with reference to FIGS. 7 to 10.

It is intended that the coil 1 is assembled upside down, with the upper winding assembly 200, spacer 400, and lower winding assembly 300 being placed into the upper housing 110 such that the openings in the pockets 405 of the spacer 400 face away from the opening of the upper housing 110, and toward the internal surface 111 of the upper housing 110 and the lower surface 202 of the upper winding assembly 200.

With reference to FIG. 7, where a bottom perspective view of the upper housing portion 110 is shown, it can be seen that the upper housing 110 comprises a number of locating projections 114 extending from the inner surface 111 of the upper housing 110 and configured to locate the winding assemblies 200, 300 and spacer 400 with respect to the housing 100 and each other. The upper housing 110 also features inner rib elements 113 extending from the inner surface 111 which form pockets 115 which are configured to not be filled with epoxy, further reducing the weight of the coil 1.

With reference to FIG. 8, where the upper winding assembly 200 is located in the upper housing portion 110, with the upper surface 201 of the upper winding assembly 200 bearing against the inner surface 111 of the upper housing 110, it can be seen that the upper winding assembly 200 features locating apertures 203 which locate over the locating projections 114 in the upper housing 110.

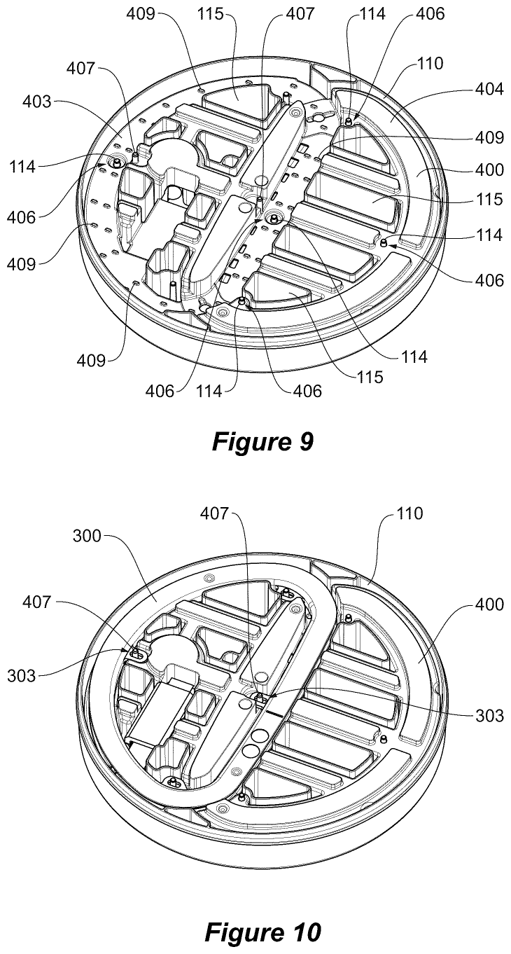

Referring now to FIG. 9, it can be seen that the next step in the assembly process is locating the spacer 400 in the upper housing portion 110 on top of the upper winding assembly 200, where the lower portion 404 of the spacer bears against a lower surface 202 of the upper winding assembly 200 and an upper portion 403 of the spacer 400 bears against the inner surface 111 of the upper housing 110. It can be seen that the spacer 400 also comprises locating apertures 406 for locating over some of the locating projections 114 in the upper housing 110.

Referring now to FIG. 10, it can be seen that the next step in the assembly process is locating the lower winding assembly 300 in the upper housing portion 110 on top of the spacer 400. With reference to FIGS. 5 and 9, it can be seen that the lower surface of the upper portion 403 of the spacer 400 comprises a plurality of separating projections 409 that the upper surface 301 of the lower winding assembly 300 bears against, such that a small gap is formed between the spacer 400 and the lower winding assembly 300 to allow for potting material, preferably epoxy, to flow between the two components. It can also be seen that the lower winding assembly 300 comprises locating apertures 303 for locating over some of the locating projections 114 in the upper housing 110 and over locating projections 407 formed in the upper portion 403 of the spacer 400.

With the winding assemblies 200, 300 and spacer 400 located in the upper housing 110, epoxy is then poured into the upper housing 110 and over the spacer 400 and winding assemblies 200, 300 such that it encapsulates the winding assemblies 200, 300 and spacer 400, where it will be appreciated that the epoxy is prevented from flowing into the pockets 405 in the spacer 400 due to an air volume being trapped that can't escape once the epoxy seals around the opening of each pocket 405, therefore creating voids, in this case air pockets, which reduces the amount of epoxy used in the coil 1, thus reducing the overall weight of the assembled component.

The lower housing 120 may then be removably secured to the upper housing 110 where it acts as a skid plate, protecting the encapsulated assembly. As previously discussed, it will be appreciated that the coil 1 would operate with or without the lower housing present.

It will be appreciated that the presence of air pockets in the coil 1 can influence the performance characteristics of the coil 1 and it will be appreciated that the shape, size and positioning of the pockets 405 can be adapted as required so as to change one or more mechanical properties of the metal detector coil 1. For example, the centre section of the coil 1 (where the two winding assemblies 200, 300 cross), in the case of a metal detector with a double D configuration, is commonly an area sensitive to relative movement between windings. The geometry of the spacer and pockets may be configured to maximise the stiffness of the coil in that area, for a given mass of coil components. For example, if the overall height of the cross section of the coil is increased by redistributing mass from close to the centreline of the coil to further from the centreline, the effect will be to increase the moment of inertia and hence resistance of the coil to bending. This in turn may reduce the relative movement between windings after mechanical loading or impact, thereby reducing the self-detection of the coil without increasing its mass. Smaller pockets may be used to provide a more rigid structure in this region. In another example, for coils that are designed to be used underwater, the overall coil density may be tuned for optimal buoyancy by adjusting the overall volume of the pockets 405.

As best shown in FIG. 6, it can be seen that in addition to the pockets 405 being formed in the D-shaped upper and lower portions 403, 404 of the spacer 400, that additional pockets 408 spanning across the upper and lower portions 403, 404 are provided. These additional pockets 408 are configured to fill the gaps in between the ribs 113 and pockets 115 formed in the upper housing 110 so as to provide rigidity, while also further reducing the amount of epoxy required to encapsulate the winding assemblies 200, 300.

While in the embodiment shown and described, the pockets 405, 408 formed in the spacer 400 enable air filled voids to be created in the potting material, it will be appreciated that in alternative embodiments these pockets 405, 408 may be pre-filled with a material having a lower density than that of the potting material, such as a foamed plastic. It will be appreciated that such an arrangement means that the pockets 405, 408 of the spacer 400 do not have to be configured to prevent flow of potting material therein.

It will also be appreciated that the spacer 400 may be configured to position both winding assemblies 200, 300 relative to each other. In the embodiment shown, the spacer 400 allows both winding assemblies 200, 300 to be assembled or positioned parallel and spaced apart from one another. It will be appreciated that in alternate embodiments, that the relative angle may be varied and that the vertical spacing between the winding assemblies 200, 300 is able to be varied by changing the depth of the spacer 400 with a relatively small weight penalty.

In the embodiment shown and described, the spacer 400 and upper and lower housings 110, 120 may be made from Acrylonitrile Butadiene Styrene (ABS), Acrylonitrile styrene acrylate (ASA) or other suitable plastics, using an injection moulding process. ABS and ASA may be used due to their favourable rigidity, mouldability, ability to adhere to epoxy, impact resistance, temperature resistance and weight, with ASA being preferable due to its environmental resistance. Polycarbonate blends may also be used, with similar properties, but trading off better impact resistance for increased weight. It will be appreciated that alternative manufacturing processes, such as 3D printing or machining will also fall within the scope of this disclosure.

While in the embodiment shown and described, the pockets 405, 408 in the spacer 400 feature openings that must be oriented away from the opening of the upper housing 110, and toward the internal surface 111 of the upper housing 110, so that they do not fill with potting material, it will be appreciated that in an alternate arrangement, the pockets 405, 408 may be manufactured without openings, such that a plurality of voids are formed within the spacer 400.

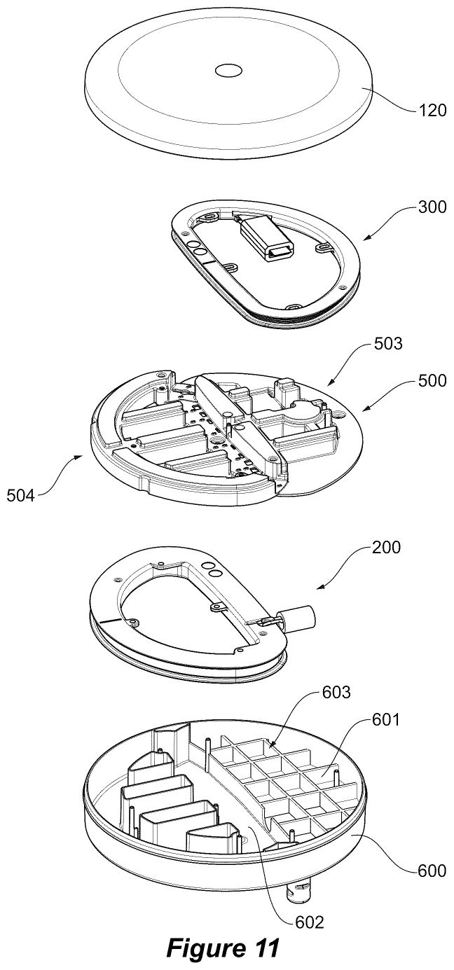

In yet another alternate arrangement, pockets may also be formed partially or fully in the housing, where the spacer provides a mating surface to fully enclose the pockets by close fitment to the housing, thereby forming a plurality of voids within the volume enclosed by the spacer and housing within the coil assembly after filling with potting material. In such an embodiment, it will be appreciated that the spacer still performs the function of creating the one or more voids, however in this instance, the voids are formed between the spacer and the housing. For example, and with reference to FIG. 11, where an alternate embodiment is shown, it can be seen that an alternative upper housing 600 is provided which features inner rib elements 601 extending from the inner surface 602 which form pockets 603 upon which an upper portion 503 of the alternative spacer 500 rests. In the embodiment shown, it can be seen that the alternate spacer 500 features a similar lower portion 504, as seen in the embodiment shown in FIGS. 1 to 10, however the upper portion 503 takes on a substantially planar form. It will be appreciated that closed volumes are formed between the pockets 603 and the alternative spacer 500, achieving a plurality of voids between the spacer 500 and the housing 600.

While in the embodiment shown and described, the spacer is a unitary component, created separately from the upper and lower housings, it is intended that various alternate arrangements will also fall within the scope of this disclosure. For example, in an alternate arrangement, there may be more than one spacer, such that a first spacer separates the upper winding assembly from the lower housing and a second spacer separates the lower winding assembly from the upper housing, and possibly even a third spacer separating the upper winding assembly from the lower winding assembly. In yet a further arrangement, the spacer may be formed as part of the upper and lower housings. In yet a further arrangement, the spacer may be formed within a winding assembly as part of a plastic former used for retaining the windings. In yet a further arrangement, more than one spacer may be configured as pairs, such that voids are created in enclosed pockets formed between the pair of spacers.

It will be appreciated that in addition to creating voids to reduce weight, the pockets formed in the spacer may also be used to prevent components from becoming encapsulated. For example, serviceable components that may be accessible through an opening (not shown) provided in the upper housing.

It will be appreciated that the use of the spacer allows freedom in the design of internal components, while maintaining a flat (or any other desired profile), solid upper housing surface without significant weight penalty, and without the upper housing surface being dictated by the task of minimising epoxy volume. It will be further appreciated that the overall cost of the coil may be reduced by the fact that a reduced amount of potting material is required to encapsulate the internal components.

It will be further appreciated that the spacer also acts to prevent electrical contact between winding assemblies and associated shielding, without the need for additional insulating material.

Throughout the specification and the claims that follow, unless the context requires otherwise, the words “comprise” and “include” and variations such as “comprising” and “including” will be understood to imply the inclusion of a stated integer or group of integers, but not the exclusion of any other integer or group of integers.

The reference to any prior art in this specification is not, and should not be taken as, an acknowledgement of any form of suggestion that such prior art forms part of the common general knowledge.

In some cases, a single embodiment may, for succinctness and/or to assist in understanding the scope of the disclosure, combine multiple features. It is to be understood that in such a case, these multiple features may be provided separately (in separate embodiments), or in any other suitable combination. Alternatively, where separate features are described in separate embodiments, these separate features may be combined into a single embodiment unless otherwise stated or implied. This also applies to the claims which can be recombined in any combination. That is a claim may be amended to include a feature defined in any other claim. Further a phrase referring to “at least one of” a list of items refers to any combination of those items, including single members. As an example, “at least one of: a, b, or c” is intended to cover: a, b, c, a-b, a-c, b-c, and a-b-c.

It will be appreciated by those skilled in the art that the invention is not restricted in its use to the particular application described. Neither is the present invention restricted in its preferred embodiment with regard to the particular elements and/or features described or depicted herein. It will be appreciated that the invention is not limited to the embodiment or embodiments disclosed, but is capable of numerous rearrangements, modifications and substitutions without departing from the scope of the invention as set forth and defined by the following claims.

1. A metal detector coil comprising a housing, at least one winding assembly and at least one spacer, wherein the or each winding assembly and spacer are at least partially encapsulated in a potting material poured into the housing, and wherein the or each spacer is configured to create one or more voids within the potting material, and wherein the shape, size or positioning of the voids may be adapted or configured to adjust one or more mechanical properties of the metal detector coil.

2. The metal detector coil as claimed in claim 1, wherein the spacer comprises one or more pockets configured to create the voids within the potting material, and wherein the shape, size or positioning of the pockets may be adapted or configured to adjust one or more mechanical properties of the metal detector coil.

3. The metal detector coil as claimed in claim 2, wherein the at least one winding assembly is separated from an internal surface of the housing by at least one spacer.

4. The metal detector coil as claimed in claim 2, wherein the one or more pockets in the or each spacer are configured to prevent flow of potting material therein, thereby creating voids within the potting material.

5. The metal detector coil as claimed in claim 4, wherein the one or more pockets in the or each spacer are open volumes configured to trap air, and prevent flow of potting material therein, such that voids are created in the potting material.

6. The metal detector coil as claimed in claim 1, wherein the metal detector coil comprises an upper winding assembly and a lower winding assembly.

7. The metal detector coil as claimed in claim 6, wherein the at least one spacer separates the lower winding assembly from an upper internal surface of the housing.

8. The metal detector coil as claimed in claim 6, wherein the at least one spacer separates the upper winding assembly from a lower internal surface of the housing.

9. The metal detector coil as claimed in claim 6, wherein the upper and lower winding assemblies are separated from one another by the at least one spacer.

10. The metal detector coil as claimed in claim 6, wherein the at least one spacer is configured to position the upper and lower winding assemblies parallel to one another.

11. The metal detector coil as claimed in claim 1, wherein the at least one spacer is configured to position and separate two or more winding assemblies assembled in a concentric arrangement within the housing.

12. The metal detector coil as claimed in claim 1, wherein the at least one spacer separates a single winding assembly from an upper internal surface of the housing.

13. The metal detector coil as claimed in claim 1, wherein the housing comprises an upper portion and a lower portion.

14. The metal detector coil as claimed in claim 1, wherein the at least one spacer is part of a former configured to retain one or more windings from the at least one winding assembly.

15. The metal detector coil as claimed in claim 1, wherein the or each spacer is configured to create one or more voids between the spacer and either or both of the housing and the at least one winding assembly.

16. The metal detector coil as claimed in claim 1, wherein the housing comprises one or more pockets and the spacer is configured to enclose the one or more pockets by close fitment to the housing, thereby forming the one or more voids within the potting material.

17. A method of assembling a metal detector coil comprising a housing, at least one winding assembly and at least one spacer, wherein the or each winding assembly and spacer are at least partially encapsulated in a potting material poured into the housing, and wherein the or each spacer is configured to create one or more voids within the potting material, the method comprising the steps of:
locating the at least one winding assembly and at least one spacer within the housing; and
encapsulating the at least one winding assembly and at least one spacer by pouring potting material into the housing, wherein voids are created within the potting material by the spacer.
